(19) United States
(12) Patent Application Publication
(10) Pub. No.: US 2007/0101639 A1
(43) Pub. Date: May 10, 2007

(54) Electric insect killer

(76) Inventor: Huang-Yu Huang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/270,560

(22) Filed: Nov. 10, 2005

(51) Int. Cl. A01M 1/22

(52) U.S. Cl. 43/112

(57) ABSTRACT

An electric insect killer includes a handle, an electric shock unit provided in the handle, a frame having a thickness to define a lower and an upper frame surface, and a plurality of conducting elements stretched in the frame. The electric elements are downward bent near two end portions to define a lower planar flapping surface and an upper U-shaped flapping surface relative to the lower and the upper frame surface. Each of the conducting elements may be extended perpendicular to or in the same direction as an extending direction of the handle, and may have a row of downward extended conducting wires provided at a lower side closer to the planar flapping surface to increase the contact area of the planar flapping surface.

### FIELD OF THE INVENTION

The present invention relates to an electric insect killer, and more particularly to an electric insect killer adapted to electrically kill all kinds of insects, including mosquitoes, cockroaches, mites, ants, etc., in the air or on a surface.

### BACKGROUND OF THE INVENTION

FIG. 1 shows a conventional electric mosquito killer 10, which is normally waved to electrically kill mosquitoes flying in the air. As shown, the electric mosquito killer 10 includes a handle 1, a frame 2, and a network formed from a plurality of conducting elements 4 longitudinally and transversely stretched in the frame 2. The handle 1 is internally provided with a shock producer (not shown), a power supply (not shown), and a switch 32, which are electrically connected to the conducting elements 4. When the switch 32 is on, power is supplied to the shock producer and the conducting elements 4, and the electric mosquito killer 10 is ready for electrically killing mosquitoes, flies, and other insects with wings.

While the conventional electric mosquito killer 10 is useful in killing flying mosquitoes, flies, etc., it is not suitable for killing mosquitoes or flies staying on a planar ground or wall surface. This is because the frame 2 has a thickness and the network of the conducting elements is usually located at a middle point between two sides of the frame 2. When the electric mosquito killer 10 is moved toward the ground or the wall surface, the conducting elements 4 located between two sides of the frame 2 do not always effectively touch and electrically kill the mosquito or the fly staying on the planar surface. When it is desired to kill the mosquito or fly staying on the planar surface, a user has to approach the flapper toward the mosquito or fly and try to electrically kill the mosquito or fly when the latter is disturbed and flies. It is uneasy to successfully kill the mosquito or fly under this condition.

Another disadvantage of the conventional electric mosquito killer 10 is that the body of the killed mosquito or fly tends to splash through the open network of conducting elements 4 in the frame 2 under the considerably high electric current supplied to the conducting elements 4, and therefore pollutes the surrounding environment.

### SUMMARY OF THE INVENTION

It is therefore a primary object of the present invention to provide an electric insect killer that is effective in electrically killing all kinds of insects, no matter they are flying in the air or staying on a planar surface.

Another object of the present invention is to provide an electric insect killer with means for catching the bodies of killed insects. The catching means is a cover removably assembled to a top of a frame of the flapper to prevent the bug bodies from splashing and polluting the environment. The contaminated cover can be then easily removed from the flapper and cleaned to meet the demand for environmental protection.

### BRIEF DESCRIPTION OF THE DRAWINGS

FIG. 1 shows a conventional electric mosquito killer;

FIG. 2 is a perspective view of an electric insect killer according to a first embodiment of the present invention;

FIG. 3a is a sectional view taken along line 3a-3a of FIG. 2;

FIG. 3b is a sectional view of an electric insect killer according to a second embodiment of the present invention;

FIG. 3c is a sectional view of an electric insect killer according to a third embodiment of the present invention;

FIG. 4 is an exploded perspective of an electric insect killer according to a fourth embodiment of the present invention;

FIG. 5 is a plan view of an electric insect killer according to a fifth embodiment of the present invention;

FIG. 6 is a perspective view of a flat conducting element included in the electric insect killer of FIG. 5;

FIG. 7 is a plan view of an electric insect killer according to a sixth embodiment of the present invention;

FIG. 8 is a sectional view taken along line 8-8 of FIG. 7;

FIG. 9 is a plan view of an electric insect killer according to a seventh embodiment of the present invention; and

FIG. 10 is a perspective view of a flat conducting element included in the electric insect killer of FIG. 9.

### DETAILED DESCRIPTION OF THE PREFERRED EMBODIMENTS

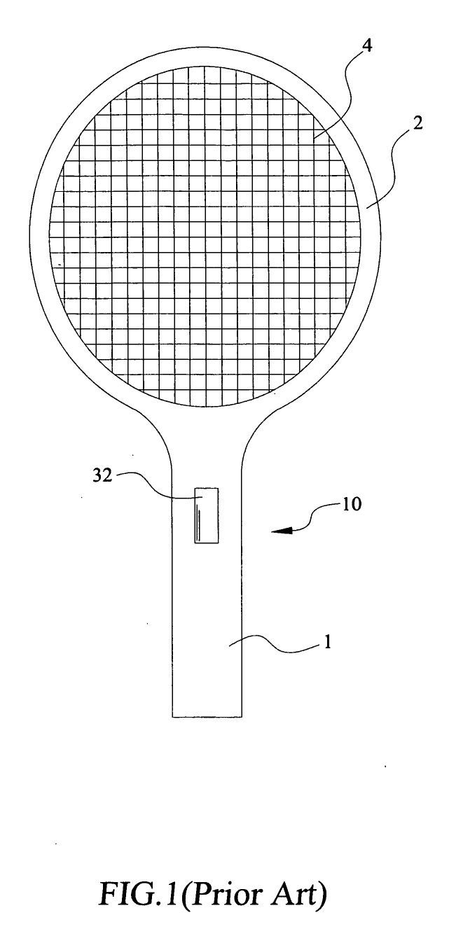

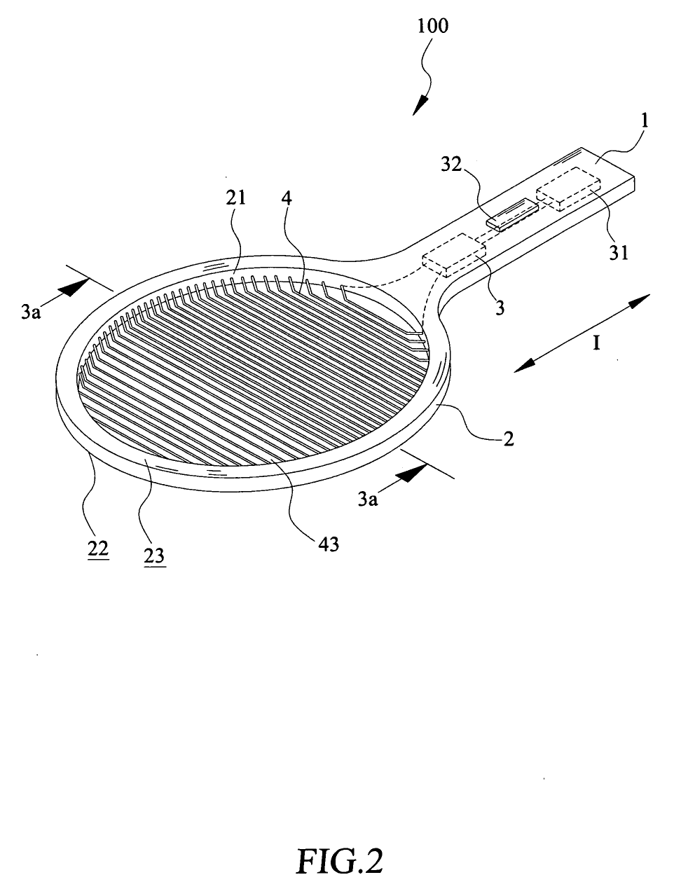

Please refer to FIG. 2 that is a perspective view of an electric insect killer 100 according to a first embodiment of the present invention. As shown, the electric insect killer 100 of FIG. 1 includes a handle 1, a frame 2, an electric shock unit 3, and a plurality of elongated conducting elements 4 stretched in the frame 2 with two ends of the conducting elements 4 fixed to an inner periphery 21 of the frame 2.

The frame 2 has a thickness and thereby defines a lower and an upper frame surface 22, 23. In the first embodiment of the present invention, since the conducting elements 4 stretched in the frame 2 are downward bent at each end portion near the inner periphery 21 of the frame 2, they also define a planar flapping side 41 and a U-shaped flapping side 41 corresponding to the lower and the upper frame surface 22, 23, respectively.

The handle 1 is integrally connected with the frame 2, and is internally provided near the frame 2 with the electric shock unit 3. The electric shock unit 3 includes a switch 32 for turning on or off a power supply device 31, which may be at least one battery (not shown) or a transformer (not shown) connectable to an external power source for supplying power to the electric insect killer 100.

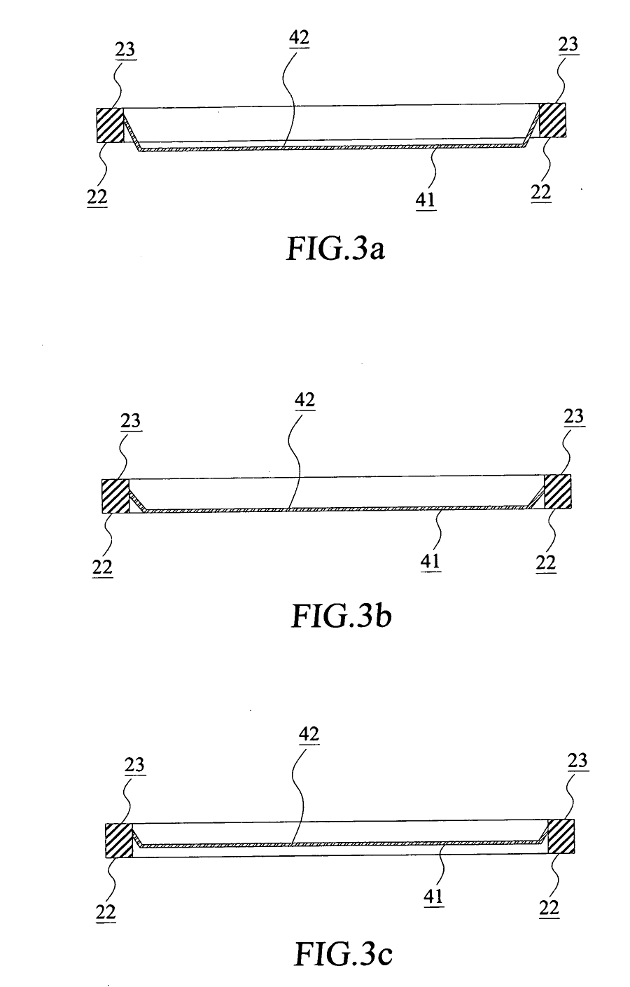

FIG. 3a is a sectional view taken along line 3a-3a of FIG. 2. Please refer to FIGS. 2 and 3a at the same time. As shown, the conducting elements 4 stretched in the frame 2 are electrically connected with the electric shock unit 3, and the conducting elements 4 are separated from one another to define a space 43 between two adjacent conducting elements 4. The planar flapping surface 41 formed by the conducting elements 4 is slightly protruded beyond the lower frame surface 22 of the frame 2, and each of the conducting elements 4 is extended in a direction perpendicular to an extending direction I of the handle 1, as shown in FIG. 2.

FIG. 3b is a sectional view of an electric insect killer according to a second embodiment of the present invention. As shown, the planar flapping surface 41 is flush with the lower frame surface 22 of the frame 2.

FIG. 3c is a sectional view of an electric insect killer according to a third embodiment of the present invention. As shown, the planar flapping surface 41 is slightly recessed from the lower frame surface 22 of the frame 2.

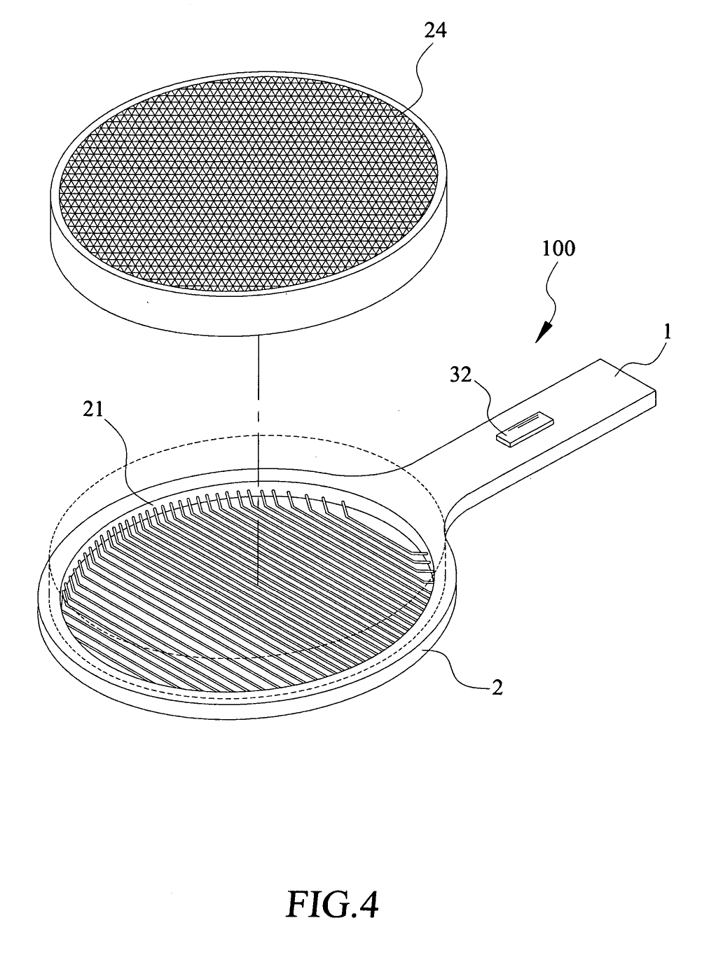

Please refer to FIG. 4 that is an exploded perspective view of an electric insect killer 100 according to a fourth embodiment of the present invention. The electric insect killer 100 in the fourth embodiment is structurally similar to the first, the second, and the third embodiment, except that the fourth embodiment further includes a cover 24 removably assembled to the inner periphery 21 of the frame 2 to locate above the U-shaped flapping surface 42. When the electric insect killer 100 with the cover 4 is used to electrically kill insects (not shown) at the planar flapping surface 41, the cover 24 works to catch bodies of the killed insects and prevent the killed insects from splashing out of the electric insect killer 100 to contaminate the surrounding environment.

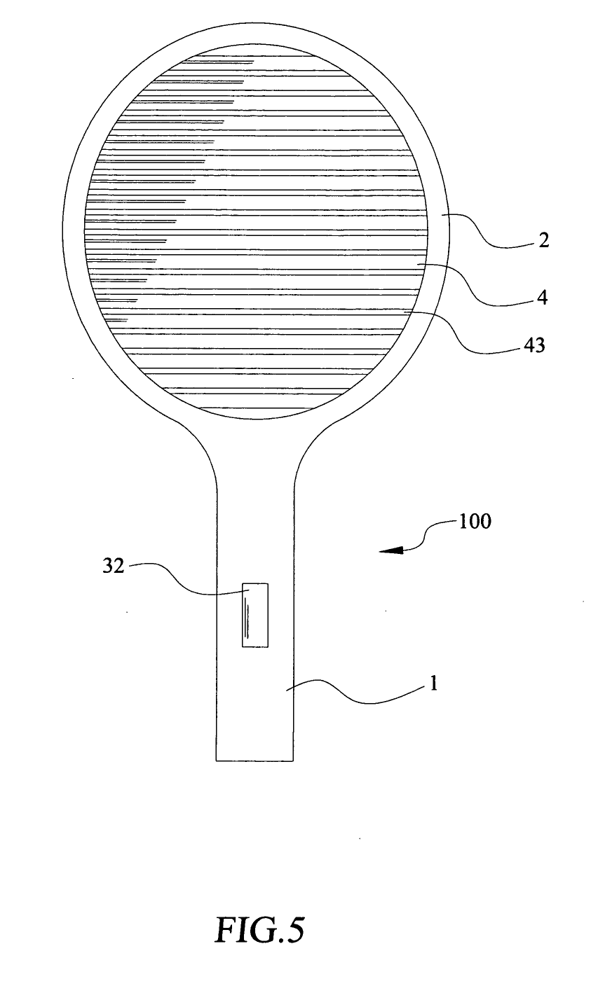

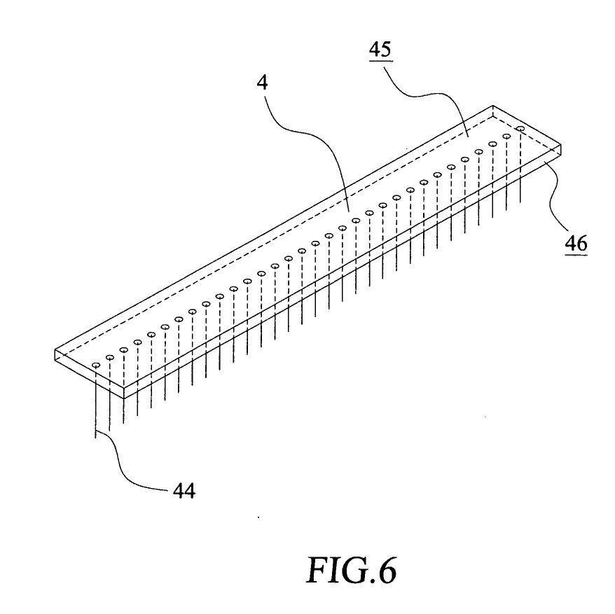

FIG. 5 is a plan view of an electric insect killer 100 according to a fifth embodiment of the present invention. The electric insect killer 100 in the fifth embodiment is different from the first to the fourth embodiments because it has a plurality of flat conducting elements 4, each of which is extended in a direction perpendicular to an extending direction I of the handle 1. FIG. 6 is a perspective view of one of the flat conducting elements 4. As shown, the flat conducting element 4 includes a pair of two opposite large contact surfaces 45 and a pair of two opposite small contact surfaces 46. The flat conducting element 4 is stretched in the frame 2 with the pair of large contact surfaces 45 separately faced upward and downward. A row of conducting wires 44 having the same polarity as the flat conducting element 4 is provided along the downward faced large contact surface 45 closer to the planar flapping surface 41, so that the conducting wires 44 are perpendicular to the planar flapping surface 41.

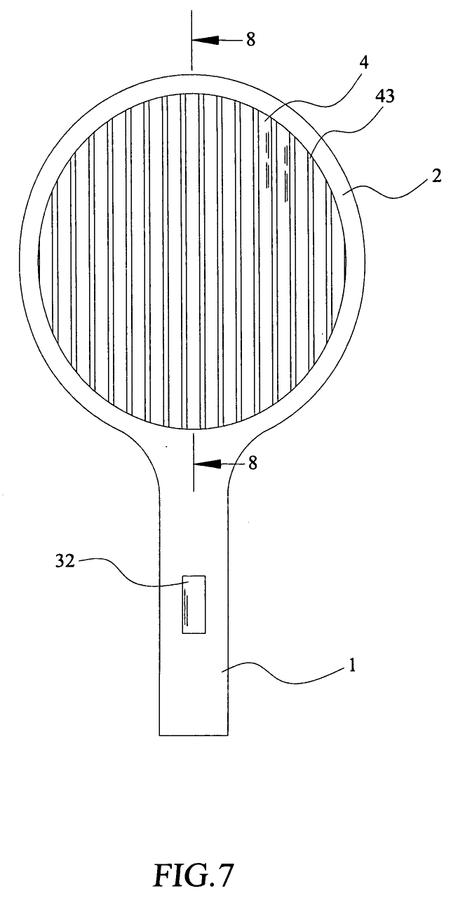

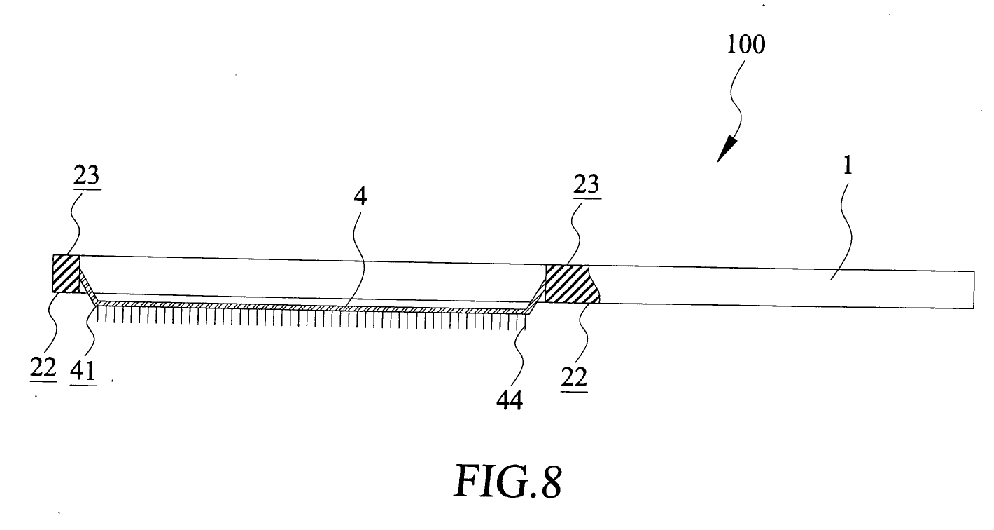

FIG. 7 is a plan view of an electric insect killer 100 according to a sixth embodiment of the present invention. The electric insect killer 100 in the sixth embodiment is similar to the fifth embodiment to include a plurality of flat conducting elements 4. However, each of the flat conducting elements 4 in the sixth embodiment is extended in a direction the same as an extending direction I of the handle 1. FIG. 8 is a sectional view taken along line 8-8 of FIG. 7. As shown, each of the flat conducting elements 4 is provided along the downward faced contact surface closer to the planar flapping surface 41 with a row of conducting wires 44 having the same polarity as the conducting element 4, so that the conducting wires 44 are perpendicular to the planar flapping surface 41.

When the electric insect killer 100 is used to kill insects staying on a rigid surface, such as the ground, a wall surface, a table top, etc., the conducting wires 44 perpendicularly protruded from the planar flapping surface 41 and having good elasticity would first get in touch with the rigid surface without colliding therewith to produce a high-volume noise. Therefore, the electric insect killer 100 may have a prolonged usable life.

In the present invention, any two adjacent conducting elements 4 have different polarities, and the conducting wires 44 provided on every flat conducting element 4 have the same polarity as the flat conducting element 4 and project from the conducting element 4 by a predetermined length. Therefore, two rows of the conducting wires 44 provided on two adjacent conducting elements have different polarities and would not contact with one another.

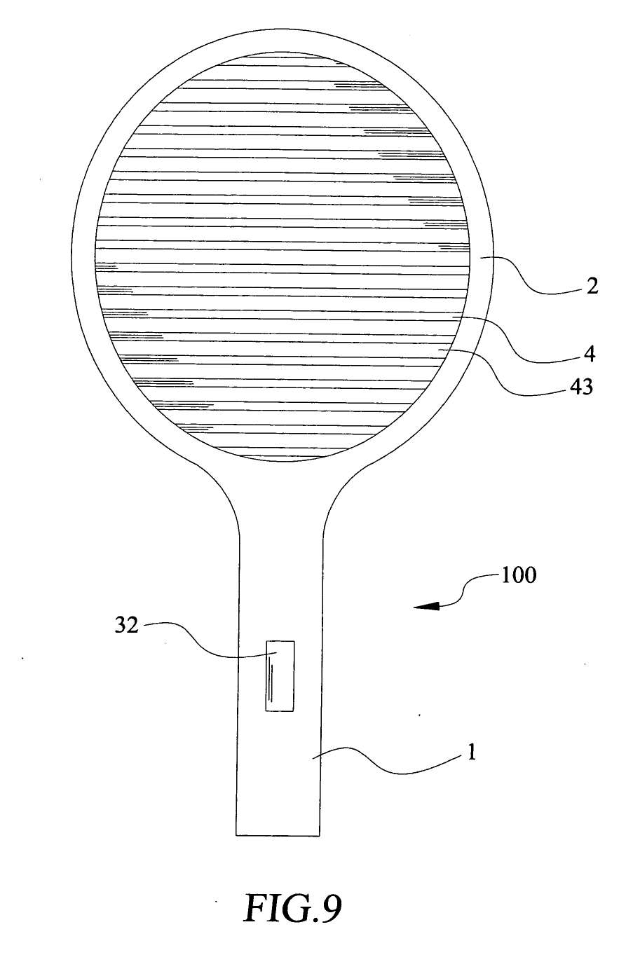

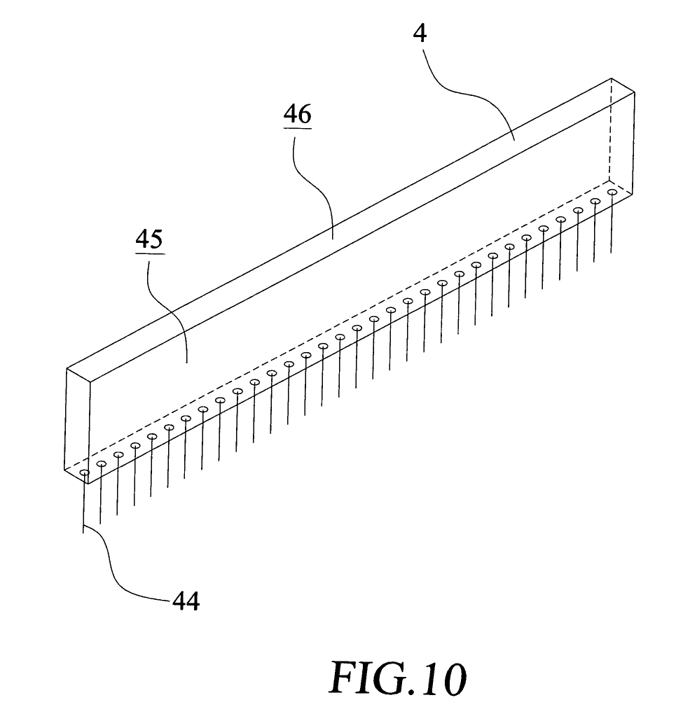

FIG. 9 is a plan view of an electric insect killer 100 according to a seventh embodiment of the present invention. As in the fifth embodiment, the electric insect killer 100 in the seventh embodiment includes a plurality of flat conducting elements 4. However, the flat conducting elements 4 in the seventh embodiment are stretched in the frame 2 with the pair of small contact surfaces 46 separately faced upward and downward. FIG. 10 is a perspective view of one of the conducting elements 4 included in the seventh embodiment of the present invention. As shown, a row of conducting wires 44 having the same polarity as the flat conducting element 4 is provided along the downward faced small contact surface 46 closer to the planar flapping surface 41, so that the conducting wires 44 are perpendicular to the planar flapping surface 41.

In brief, the electric insect killer according to the present invention has the following advantages and is more practical for use. The electric insect killer may effectively electrically kill insects flying in the air or staying on a planar surface, such as on the ground or on a wall surface. The electric insect killer provides an increased contact area with a planar surface to effectively electrically kill insects staying on the planar surface without colliding with the planar surface to produce high-volume noises, enabling the electric insect killer to have a prolonged usable life. The electric insect killer may have a cover removably assembled thereto to prevent the bodies of killed insects from splashing and polluting the surrounding environment.

What is claimed is:

1. An electric insect killer, comprising a handle, an electric shock unit provided in said handle, a frame having a thickness to define a lower and an upper frame surface, and a plurality of conducting elements stretched in said frame; said electric insect killer being characterized in that said electric elements are downward bent near two end portions to define a lower planar flapping surface and an upper U-shaped flapping surface relative to said lower and said upper frame surface.

2. The electric insect killer as claimed in claim 1, wherein said lower planar flapping surface is protruded beyond said lower frame surface by a predetermined distance.

3. The electric insect killer as claimed in claim 1, wherein said lower planar flapping surface is recessed from said lower frame surface by a predetermined distance.

4. The electric insect killer as claimed in claim 1, wherein said lower planar flapping surface is flush with said lower frame surface.

5. The electric insect killer as claimed in claim 1, further comprising a cover removably assembled to said frame to locate above said upper U-shaped flapping surface.

6. The electric insect killer as claimed in claim 1, wherein each of said conducting elements stretched in said frame is extended in a direction perpendicular to an extending direction of said handle.

7. The electric insect killer as claimed in claim 6, wherein each of said conducting elements is provided at a lower side closer to said planar flapping surface with a row of conducting wires, and said conducting wires being downward extended perpendicular to said lower side of said conducting element.

8. The electric insect killer as claimed in claim 1, wherein each of said conducting elements stretched in said frame is extended in a direction the same as an extending direction of said handle.

9. The electric insect killer as claimed in claim 8, wherein each of said conducting elements is provided at a lower side closer to said planar flapping surface with a row of conducting wires, and said conducting wires being downward extended perpendicular to said lower side of said conducting element.
